(19) United States
(12) Patent Application Publication
(10) Pub. No.: US 2002/0046359 A1
(43) Pub. Date: Apr. 18, 2002

(54) Method and apparatus for secure and fault tolerant data storage

(76) Inventor: Scott T. Boden, LaJolla, CA (US)

Correspondence Address: EPSTEIN, EDELL, SHAPIRO & FINNAN, LLC, Suite 400, 1901 Research Boulevard, Rockville, MD, 20850-3164, US

(21) Appl. No.: 09/810,004

(22) Filed: Mar. 16, 2001

Related U.S. Application Data
(60) Provisional application No. 60/189,932, filed on Mar. 16, 2000.

(51) Int. Cl. G06F 11/08

(52) U.S. Cl. 714/6

(57) ABSTRACT

A computer system including software manipulates data prior to storage on media disposed within a system storage device. The data is initially stored sequentially within a first array, while a pseudo-random number sequence is generated in accordance with a seed value to identify storage locations for associated data bits within a second array. The second array is stored sequentially on the media to randomly distribute the data across that media. In order to retrieve the data in original form, the entire contents of the media are retrieved and stored in a third array. The sequence is reproduced in accordance with the seed value, while data bits are retrieved in the order of the sequence and stored in temporary storage to recover the data. The seed value may further serve as a password to maintain the data in a secure fashion.

### CROSS REFERENCE TO RELATED APPLICATIONS

This application claims priority to U.S. Provisional Patent Application Ser. No. 60/189,932, entitled “Psuedo-Random Data Convolution Algorithm” and filed Mar. 16, 2000, the disclosure of which is incorporated herein by reference in its entirety.

### BACKGROUND OF THE INVENTION

1. Technical Field

The present invention pertains to data storage systems. In particular, the present invention pertains to a data storage system that stores information in apseudo-random manner across media of a mass storage device (e.g., CD-ROM drive, floppy disk drive and drives for other removable or non-removable optical or magnetic type disks) to enhance data longevity, error correction and security.

2. Discussion of Related Art

Various storage devices are currently utilized with computer systems to store data. These storage devices typically receive removable storage media (e.g., CD-ROMs, floppy diskettes, Zip disks, etc.) generally having a rotatable disk with a plurality of tracks and sectors defined therein to contain data. The storage media typically store data from files in a sequential manner (e.g., physically proximate each other), while the files, in turn, are sequentially stored on the media. Although the sequential data arrangement employed by these devices may enhance data access rates, a defective or damaged disk surface may produce data errors of a magnitude sufficient to prevent recovery of data stored within or proximate the damaged or defective disk sections. These types of errors are typically limited to a few files, however, data within those files is generally not recoverable. The data loss may result in severe consequences, especially when the discarded data is of a secure or critical nature. In addition, the information stored on the storage media is generally accessible to any users employing a storage device compatible with that media, thereby facilitating compromise of stored information integrity.

The related art has attempted to overcome the aforementioned problems by providing systems and/or methods that distribute data in various fashions within a memory device. For example, U.S. Pat. No. 4,789,902 (Shimura) discloses an image signal processing method for storing a series of image signals on a recording medium or transmitting the image signals to a receiving device, and reproducing the image from the stored or transmitted image signals. The image signals are arrayed in the array sequence of scanning lines on an image. The series of image signals is divided into predetermined units in the course of storing or transmitting those signals, while the image signals are stored or transmitted by changing the sequence of the respective units so that the units which were adjacent to each other do not adjoin each other. The image is reproduced by rearranging the units in the original sequence in the course of image reproduction.

U.S. Pat. No. 5,276,826 (Rau et al) discloses a computer system having a multimodule memory system. Access to the memory modules for reading or writing are undertaken in parallel. The memory system is addressed by input addresses and includes a map unit for transforming the input addresses to output addresses in a pseudo-random manner to distribute memory accesses uniformly among the memory modules. The contention resulting from multiple concurrent attempts to access the same memory module is thereby reduced. The map unit performs address transforms that are repeatable so that the same input address maps to the same output address and that are one-to-one such that each input address maps to one and only one output address.

U.S. Pat. No. 5,305,324 (Demos) discloses an error correction and detection interface between a high speed data channel and a high capacity digital data recording tape system. The interface includes a data scrambling and translation scheme which provides an additional layer of error correction to the data as it is recorded. The data scrambling and translation scheme permits the correction of normally uncorrectable large error bursts on digital tape devices.

U.S. Pat. No. 5,799,033 (Baggen) discloses an errorprotected transmission method. Data is transmitted via a signal containing a number of simultaneously active modulated frequency channels. The data is encoded in an error protecting code, while successive data items are mapped pseudo-randomly to different frequency channels. The pseudo-random mapping is realized by writing the data items into memory in one order and reading them from memory in another order. Successive signals are each modulated in this way. The memory locations vacated upon reading data items for the modulation of one signal are filled by data items for modulating the next successive signal. This is maintained by permuting the order of the memory locations in which the data items are written for each successive signal.

The related art suffers from several disadvantages. In particular, the Demos system utilizes plural memory modules to arrange data in accordance with a predetermined offset scheme, thereby significantly increasing system complexity and cost. The Shimura method distributes or rearranges data that is partitioned or grouped into units, while the Rau et al system employs a pseudo-random mapping of a memory input address to a memory output address for achieving relatively uniform access of a plurality of memory modules and employs data typically grouped and stored in the form of data words having several bits. Thus, logically adjacent data within a unit or word is stored at adjacent locations. These techniques basically limit distribution of data within memory and, with respect to storage media, increase the risk of unrecoverable data loss in the event defects occur in the storage media where the data is stored. The Baggen method employs apseudo-random interleaving scheme where the data is distributed with respect to frequency channels, while the above described systems and/or methods generally utilize offset and/or interleaving schemes to distribute data. These manners of distributing data tend to limit and provide a relatively uneven distribution of data within the memory space, thereby increasing risk of unrecoverable data loss with respect to storage media in the event of storage media defects as described above. In addition, the systems and methods described above do not provide a manner for a user to selectively control access to the distributed information.

The present invention overcomes the aforementioned problems of the related art by distributing data in a pseudo-random fashion across storage media. Since the random distribution enables sequentially stored data bits to be associated with different files, the impact of a media surface defect is typically limited to a few bits within selected files. These errors may be corrected with various conventional error correction techniques, thereby permitting recovery of impacted data. In addition, the random distribution maybe determined in accordance with a particular seed value that is farther required to recover the data in original form. The seed value basically serves as an access code or password to retrieve the data, while enabling storage of data in a secure manner. Thus, the present invention provides data storage with enhanced security and fault tolerance.

### OBJECTS AND SUMMARY OF THE INVENTION

Accordingly, it is an object of the present invention to distribute data in a random fashion across storage media to provide enhanced data security and fault tolerance.

It is another object of the present invention to randomly distribute data across storage media based on a seed value that serves as a security measure to selectively enable access to the stored data.

Yet another object of the present invention to store data across storage media in a manner to detect and correct errors within the data.

The aforesaid objects may be achieved individually and/or in combination, and it is not intended that the present invention be construed as requiring two or more of the objects a to be combined unless expressly required by the claims attached hereto.

According to the present invention, a computer system including software manipulates data prior to storage on storage media disposed within a system storage device. The data is initially stored in a sequential manner within a first array. A random number within a pseudo-random number sequence is generated for each sequential bit within the first array and serves as an index to identify a storage location or position for the associated bit within a second array. The sequence of random numbers is generally a non-repeating sequence that is generated in accordance with a seed value. The data from the first array is thus distributed in a pseudo-random fashion across the second array in accordance with the generated pseudo-random number sequence. The second array is subsequently stored in a sequential manner on the storage media, thereby randomly distributing the data across that media.

In order to retrieve the data in original form, the entire contents of the storage media are retrieved and stored in a third array. The pseudo-random number sequence is reproduced in accordance with the seed value with each generated random number serving as an index within the third array to retrieve a corresponding data bit. The data bits are retrieved in accordance with the reproduced pseudo-random number sequence and stored in temporary storage to recover the data in original form. The seed value for the random number generator may further serve to maintain the data in a secure fashion since the seed value is required to distribute the data in a pseudo-random fashion and recover the data in original form. Further, the random data distribution limits errors due to media defects to only a few bits within several files, where the data bits may be recovered with conventional error correction techniques.

The present invention may be employed with storage media having greater storage capacities than the available computer system Random Access Memory (RAM) by distributing data in a pseudo-random fashion as described above within sequential sections of the media or by utilizing operating system virtual memory to accommodate the storage media capacity. In addition, plural instances of randomly distributed data may be stored on the storage media to enhance error detection and recovery. Since each data bit is stored on the storage media in plural instances, the data bit value appearing within a predetermined quantity of instances may be considered the appropriate data bit value. Thus, the system may detect and correct errors within the data in accordance with the appropriate data bit values.

The above and still further objects, features and advantages of the present invention will become apparent upon consideration of the following detailed description of specific embodiments thereof, particularly when taken in conjunction with the accompanying drawings wherein like reference numerals in the various figures are utilized to designate like components.

### BRIEF DESCRIPTION OF THE DRAWINGS

FIG. 1 is a view in perspective of an exemplary computer system for storing data in a pseudo-random fashion across storage media and retrieving the data in original form according to the present invention.

FIGS. 2a-2b are a procedural flow chart illustrating the manner in which the computer system distributes data in a pseudo-random fashion across storage media according to the present invention.

FIG. 3 is a procedural flow chart illustrating the manner in which the computer system retrieves data in original form from storage media having the data distributed thereon in a pseudo-random fashion according to the present invention.

### DETAILED DESCRIPTION OF THE PREFERRED EMBODIMENTS

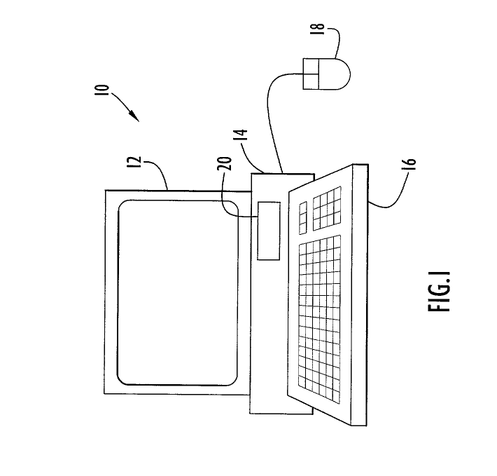

An exemplary computer system of the present invention for storing data in a pseudo-random fashion across storage media and retrieving that data in original form is illustrated in FIG. 1. Specifically, computer system 10 is typically implemented by a conventional personal or other computer system preferably equipped with a display or monitor 12, a base 14 (e.g., including the processor, memories and internal or external communication devices (e.g., modem, network cards, etc.)), a keyboard 16 and optional mouse 18 or other input device. Base 14 may further include one or more internal or external storage devices or disk drives 20 (e.g., drives accommodating CD-ROMs, floppy diskettes, Zip disks, etc.) to store data or information. These drives typically accommodate removable storage media (e.g., CD-ROMs, floppy diskettes, Zip disks, etc.) preferably employing a rotatable disk having plural tracks and sectors defined therein to store information in a sequential manner. Computer system 10 includes software for facilitating pseudo-random data distribution across the media surface and associated data retrieval therefrom and appropriate components (e.g., processor, disk storage or hard drive, etc.) having sufficient processing and storage capabilities to effectively execute the software. The computer system preferably includes a Windows environment, but may alternatively utilize any of the major platforms (e.g., Linux, Macintosh, Unix, OS2, etc.). The computer system, under software control, implements the data storage system of the present invention for distributing data in a pseudo-random fashion across storage media and subsequently retrieving that data in original form.

The present invention is typically utilized with storage devices having read and write capabilities and employing a rotatable disk-based media with plural tracks and sectors defined therein for storing data (e.g., CD-ROM, floppy diskette, Zip disk, etc.) as described above. The computer system may be implemented by any processing system or embedded device capable of interfacing a storage device or disk drive. Computer system 10 includes software to store data in a pseudo-random fashion across storage media disposed within a computer system storage device and retrieve that data from the storage media in original form as described below. Basically, the present invention evenly distributes data bits across the surface of the selected storage media. When data bits for a particular file are distributed in this fashion, the entire media or disk is generally required to fail to lose all the data stored thereon. For example, if five percent of a disk surface having data stored thereon in accordance with the present invention is damaged, five percent of data in each of the stored files is lost. However, the lost data is recoverable via conventional error correction techniques. With respect to sequential storage of data, all data in five percent of the stored files is lost, without possibility of recovery. The present invention benefits from the localization of physical disk damage to a portion of the disk. Thus, the present invention enables recovery of lost data due to deep scratches or gouges (e.g., even circular along track paths) or other severe disk damage (e.g., a hole drilled through the media) that occupy a low percentage of disk surface area.

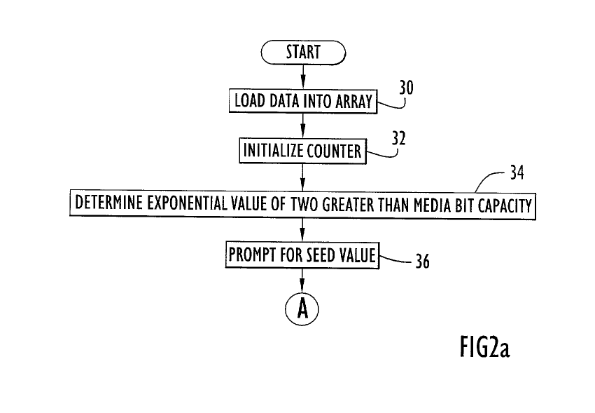

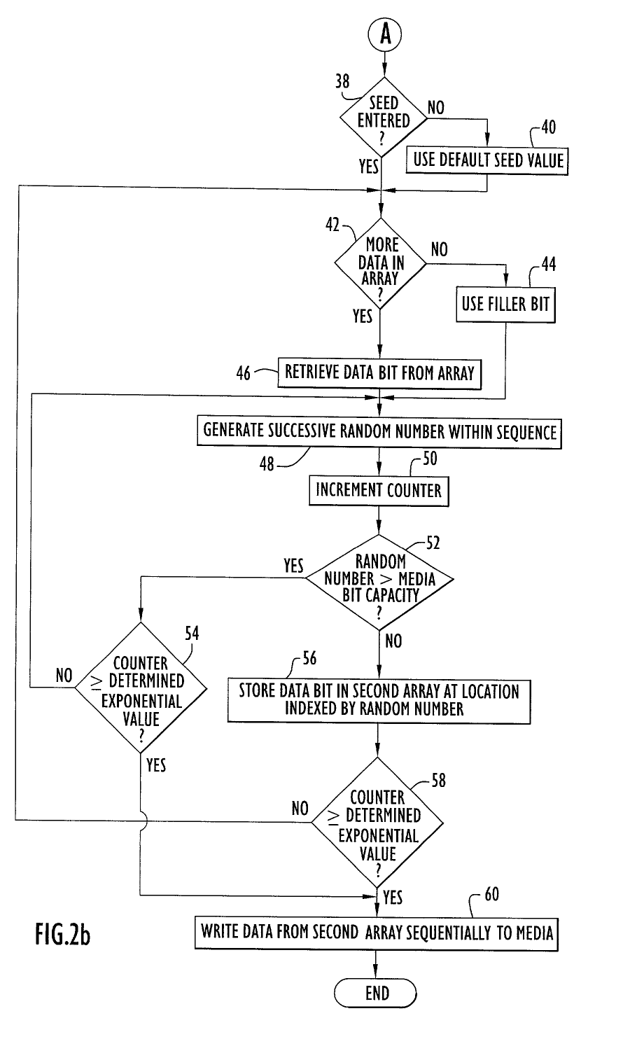

The manner in which the computer system stores data in a pseudo-random fashion across storage media disposed within a computer system storage device is illustrated in FIGS. 2a-2b. Initially, data is selected by a user for storage on storage media disposed within a system storage device. The selected data is loaded into an array or other data structure, typically a Random Access Memory (RAM) buffer array, at step 30. For example, if one hundred twenty-eight files, each having ten thousand bytes of data, are to be stored, the files (e.g., 1,280,000 bytes of data) are placed in the buffer array. A sequence counter is initialized at step 32, while the system determines at step 34 an exponential value of two (e.g., the value of two raised to a particular power) that is closest to and exceeds the bit capacity of the storage media. For example, a 3.5 inch floppy diskette has a storage capacity of approximately 1.44 megabytes or 11.52 megabits (i.e., 1.44 megabytes multiplied by eight since each byte contains eight bits). The exponential value of two closest to and greater than 11.52 megabits is 2²⁴. Thus, the sequence counter for the 3.5 inch floppy disk may be implemented by a twenty-four bit binary counter having a maximum of 16,777,216 states. The exponential value defines a range upper limit for generating a sequence of non-repeating random numbers as described below. The computer system automatically ascertains the storage capacity of the storage media in order to determine the exponential value. The sequence counter maintains a quantity of random numbers generated to indicate when each number within the exponential value range (e.g., typically the range of zero to the exponential value minus one) has been generated.

The system prompts a user at step 36 to enter a seed value for generating a pseudo-random number sequence. If a seed value is entered as determined at step 38, the entered seed value is utilized by a pseudo-random number generator to generate a non-repeating sequence of random numbers as described below. Otherwise, a default seed value is retrieved at step 40 for utilization by the random number generator to generate the sequence. The seed value may be any value within the exponential value range. For example, since 2²⁴ or 16,777,216 is the exponential value greater than the storage capacity of the 3.5 inch floppy disk (e.g., having a storage capacity of 1.44 megabytes) as described above, any of approximately 2²⁴ seed values may be utilized. Further, since a Zip disk has a storage capacity of approximately one-hundred megabytes, any value within an excess of 1.6 billion seed values may be utilized. The default seed value is used for general interoperability between systems (e.g., the default seed value is the same to enable reproduction of the pseudo-random sequence and retrieval of information across plural systems), while custom seed values may be utilized to effectively encrypt the data for enhanced data security as described below.

Data bits within the buffer array are sequentially retrieved and stored in a pseudo-random fashion within a holding array or other data structure having a capacity similar to that of the intended storage media (e.g., 1.44 megabytes in the case of a 3.5 inch floppy diskette). In particular, the system determines the presence of unprocessed data within the buffer array at step 42. If unprocessed data is present, the system retrieves the next data bit within the buffer array at step 46. Otherwise, a filler or pad bit is retrieved by the system at step 44. The filler bit is basically employed when storing a quantity of data less than the storage media capacity to facilitate completion of the pseudo-random number sequence and to ensure usage of virtually the entire storage media (e.g., the filler bit is typically stored at residual locations within the storage media not receiving data from the buffer array). The random number generator utilizes the seed value at step 48 to generate a random number within a nonrepeating pseudo-random number sequence, while the sequence counter is incremented at step 50 to maintain the quantity of random numbers generated within the sequence. The generated random numbers in the sequence have values within the exponential value range and each generally serve as an index into the holding array to identify the storage location for an associated retrieved or filler bit as described below. The random number may be generated by an operating system or via a call to a software function (e.g., a standard function call within the ‘C’ programming language). A pseudo-random sequence is utilized to enable reproduction of particular sequences in response to utilization of corresponding seed values. In other words, a particular seed value enables generation of the same corresponding pseudo-random number sequence. This feature enables the sequence to be reproduced for retrieving data in original form as described below.

When the generated random number is less than or equal to the media bit storage capacity (e.g., the random number is within the media storage capacity space) as determined at step 52, the system stores the associated retrieved or filler bit within the holding array location identified by the generated random number at step 56. If the generated random number exceeds the media bit capacity (e.g., the random number is outside the media storage capacity space), the system determines at step 54 whether or not the sequence counter is greater than or equal to the exponential value (e.g., whether or not each of the values within the exponential value range has been generated). If the sequence counter is less than the exponential value (e.g., additional values have not been generated), the system generates the next random number within the sequence at step 48. In effect, a generated random number exceeding the media bit capacity identifies a storage location beyond the bounds of the storage media and holding array. Accordingly, the system generates successive random numbers within the pseudo-random number sequence until ascertaining a value within the media bit and holding array capacities, while generated values outside the media and holding array capacities are basically ignored.

When the counter attains the determined exponential value, each value within the exponential value range has been generated. Thus, each retrieved data bit has been stored in a location within the holding array identified by a corresponding random number. When the system determines at steps 54 or 58 that the counter has attained a value equal to or greater than the determined exponential value (e.g., all values within the exponential value range have been generated), the holding array is written sequentially to the storage media at step 60. The physical writing of the data to the storage media is in a track/sector format, however, the arrangement of data within the holding array basically serves to produce a random data distribution of the original data across the storage media. The resulting distribution evenly distributes each bit from a file across the surface of the storage media. Although defects encountered on the storage media surface may affect a few bits of several files, these errors may be routinely corrected with conventional error correction techniques, such as Reed Solomon.

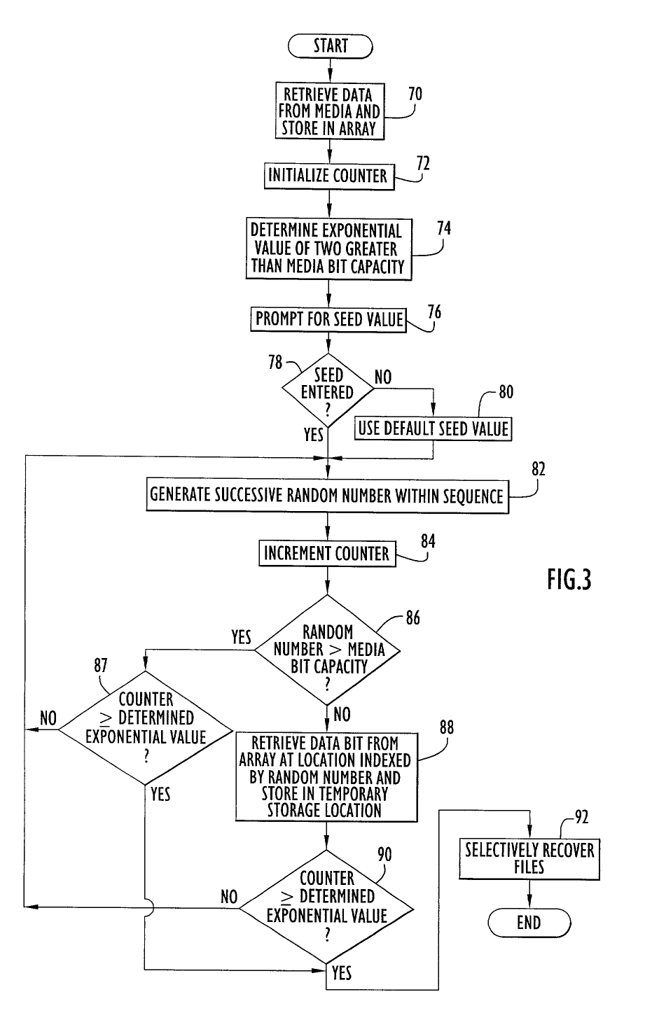

The manner in which the computer system retrieves data in original form from storage media having the data distributed thereon in a pseudo-random fashion is illustrated in FIG. 3. Initially, the contents of the storage media are retrieved and stored in a working array or other data structure at step 70. The working array has a capacity to store the entire contents of the storage media. A sequence counter is initialized at step 72, while the system determines at step 74 an exponential value of two (e.g., the value of two raised to a particular power) that is closest to and exceeds the media bit capacity in substantially the same manner described above. The computer system automatically ascertains the storage capacity of the storage media in order to determine the exponential value.

The system prompts a user at step 76 for the seed value utilized to generate the pseudo-random number sequence for randomly distributing data across the storage media. The seed value basically serves as a password to enhance data security since the data order is virtually impossible to attain without the original seed value utilized to initially distribute that data. If a seed value is entered as determined at step 78, the entered seed value is utilized by a pseudo-random number generator to generate the pseudo-random number sequence as described below. Otherwise, a default seed value is retrieved at step 80 for use by the random number generator to produce the sequence. The default seed value is generally a common value to facilitate sharing of the storage media between plural locations or systems as described below.

The random number generator utilizes the seed value at step 82 to generate a random number within a non-repeating pseudo-random number sequence and having a value within the exponential value range as described above. The random number generator basically reproduces the same sequence utilized to randomly distribute the data, thereby enabling the system to retrieve that data in the proper order. The sequence counter is incremented at step 84 to maintain the quantity of random numbers generated. If the generated random number is less than or equal to the media bit storage capacity as determined at step 86, the system retrieves the bit within the working array from a location identified by the generated random number, and stores the retrieved bit in a sequential manner within a temporary storage area on the system at step 88. When the generated random number exceeds the media bit capacity, the system determines at step 87 whether or not the sequence counter is greater than or equal to the exponential value (e.g., whether or not each of the values within the exponential value range has been generated). If the counter is less than the exponential value (e.g., additional values have not been generated), the system generates the next random number within the sequence at step 82. In effect, a generated random number exceeding the media bit capacity identifies a storage location beyond the bounds of the storage media and working array. Accordingly, the system repeatedly generates successive random numbers in the pseudo-random number sequence until ascertaining a value within the media storage and working array capacities to identify the next sequential data bit, while generated random numbers outside the media storage and working array capacities are basically ignored.

When the sequence counter reaches the determined exponential value, each value within that range has been generated. Thus, each bit stored on the media has been retrieved and placed in the appropriate order within the temporary storage area. When the system determines that the sequence counter has attained a value equal to or greater than the exponential value (e.g., all values within the exponential value range have been generated) at steps 87 or 90, the files in the temporary storage area are selectively recovered at step 92. Basically, a file structure is displayed to the user to enable selection of files. The system retrieves the selected files from the temporary storage area for permanent storage to user specified locations.

The present invention may further be employed with storage media having capacities that exceed the capacity of available RAM or the buffer array associated with the computer system. In particular, the system basically partitions the storage media space into memory blocks each having a storage capacity similar to or less than that of the available RAM or buffer array. The data is similarly partitioned into sections having a quantity of data sufficient to be accommodated by a corresponding memory block. Each data section is distributed in a random fashion across the corresponding memory block in substantially the same manner described above. The memory blocks having randomly distributed data are sequentially stored on the storage media. For example, the present invention may accommodate a Zip disk having a capacity of one-hundred megabytes by storing data on the disk in five sequential blocks, each having a five megabyte capacity and data distributed in a random fashion within that block. This provides the advantage of rapid formatting, but distributes data in a random fashion only within the blocks (e.g., not across the storage media).

Alternatively, operating system virtual memory may be utilized for storage media having capacities exceeding those of the computer system available RAM or buffer array. Basically, the virtual memory feature of an operating system interchanges RAM memory blocks with hard disk blocks to simulate additional system RAM. The system may randomly distribute data across the storage media as described above by utilizing virtual memory (e.g., the simulated RAM) to accommodate the storage media capacity. This enables random data distribution across the storage media, but reduces formatting efficiency due to overhead generated by the memory block interchanges providing the virtual memory.

The present invention may further enhance error recovery performance by providing additional error correction schemes. Initially, the entire capacity of the storage media is utilized by the present invention regardless of the quantity of data to be stored. Accordingly, storage space on the storage media is available when the quantity of data to be stored is less than the storage media capacity. For example, the system may store two-hundred kilobytes of data across a floppy diskette (e.g., having a 1.44 megabyte storage capacity) in a random fashion as described above, thereby enabling the floppy diskette to have 1.24 megabytes of available storage (e.g., the available storage typically stores filler bits as described above). The present invention may utilize the available storage to repeatedly store the data in a random fashion as described above (e.g., additional copies of the data may be placed and/or appended to the data within the buffer array and processed for storage across the media as described above). A header is placed toward the initial location of the storage media to indicate the block size of the originally stored data. This information is utilized to determine when stored data starts to repeat within the storage media.

The system utilizes a consensus scheme to identify incorrect or erroneous bits within the data. Specifically, each data bit is typically stored on the storage media at plural locations due to the storage of the additional data copies. The value for a data bit is retrieved from each instance of the data (e.g., from the data and corresponding additional data copies) stored on the storage media. The retrieved values are compared where the value for the data bit appearing within a predetermined quantity of data instances may be considered to be the correct value. For example, when a data bit is stored at six locations on the storage media (e.g., when the data and five additional copies thereof are stored on the storage media), the value of the data bit that appears within four or more data instances may be considered to be the correct value. If a data bit appears twice on the media (e.g., when the data and one additional copy thereof is stored on the storage media), the value of the data bit within the data instance having no errors (e.g., whether or not recoverable) may be considered to be the correct value. The stored data bits may be subsequently updated with the appropriate values for error recovery.

Operation of the present invention is described. The present invention is typically implemented by a personal computer having a Windows type environment and a software module executable by a user. The user executes the software module and selects files for storage, preferably within a pop-up or other window. Subsequently, the user indicates the destination storage device having storage media disposed therein to receive the selected data. The system automatically determines the storage media capacity and the pseudo-random number sequence length (e.g., exponential value) sufficient to perform the random data distribution. The user is prompted to enter a seed value. If no seed value is entered, a default seed value is utilized as described above. The system performs the data distribution and storage as described above. This may be accomplished as a background task (e.g., in a Windows environment). The status of the operation may be displayed, while a completion indication is typically displayed upon termination of the operation.

In order to retrieve randomly distributed information from storage media, the user executes the software module. The system prompts the user for the seed value utilized to store the original data. If no seed value is entered, the default seed value is utilized as described above. The system retrieves the data and places the data in original form into a temporary storage area on the system (e.g., a system hard drive) as described above. A file structure is displayed to the user to facilitate selection of files for permanent recovery (e.g., storage to a desired location).

The software of the present invention is typically implemented in the ‘C’ programming language, however, any suitable high or low level language may be utilized, especially those that may be ported to all common computers. The present invention may be utilized with any removable disk architecture having any storage capacity in substantially the same manner described above. Further, storage devices or drives may be manufactured to utilize the random data distribution and retrieval features of the present invention as a native interface.

It will be appreciated that the embodiments described above and illustrated in the drawings represent only a few of the many ways of implementing a method and apparatus for secure and fault tolerant data storage.

The computer system of the present invention may be implemented by any personal or other type of computer system (e.g., IBM-compatible, Apple, Macintosh, laptop, palm pilot, main frame, minicomputer, microcomputer, etc.) or processing device or circuitry capable of interfacing a storage device. The computer system of the present invention may include any commercially available operating system (e.g., Windows, OS/2, Unix, Linux, etc.). The computer system of the present invention may further include any commercially available or custom software, any quantity of any types of input devices (e.g., keyboard, mouse, voice recognition, etc.) and any quantity of any types of storage devices (e.g., CD-ROM drive, DVD drive, floppy diskette drive, Zip drive, hard disk drive, etc.). The present invention may be utilized with any quantity of any types of removable or non-removable storage media (e.g., magnetic media, optical media, magneto-optical media, tapes, disks, memory devices or circuits, etc.) of any shape, size or storage capacity. The media may store data in any fashion and include any quantity of data storing mechanisms (e.g., tracks, sectors, etc.). The present invention may be utilized to store any type or quantity of information, and may distribute the data in any desired portions or units having any quantity of bits (e.g., bit, byte, word, etc.). Further, the present invention may accommodate any quantity of drives having the same or different storage media.

It is to be understood that the software for the computer system of the present invention maybe implemented in any desired computer language and could be developed by one of ordinary skill in the computer arts based on the functional descriptions contained in the specification and flow charts illustrated in the drawings. The computer system of the present invention may alternatively be implemented by hardware or other processing circuitry. The various functions of the computer system may be distributed in any manner among any quantity of computer or processing systems or circuitry and/or among any quantity of software and/or hardware modules. The software and/or algorithms described above and illustrated in the flow charts may be modified in any manner that accomplishes the functions described herein. For example, the counters may maintain the amount of data stored instead of the exponential value to control termination of storage and retrieval. The holding array in this case is initialized with filler bits, while the present invention only stores or retrieves data in selected locations to reduce processing (e.g., the loop is executed for the amount of data instead of the exponential value range).

The present invention may reside on any communications network (e.g., LAN, WAN, Internet, Intranet, etc.), while end-user computer systems may include any conventional or other communications devices to communicate over the network to utilize or access the present invention and receive the randomly distributed data or data in original form.

The data storage system of the present invention maybe implemented by any quantity of computer systems, and may reside on a server, end-user or other third-party computer system or any combination of these computer systems. The software of the present invention may be available on recorded medium (e.g., floppy diskettes, CD-ROM, memory devices, etc.) for use on stand-alone systems or systems connected by a network, or may be downloaded (e.g., in the form of carrier waves, packets, etc.) to systems from a network.

The arrays and temporary storage area of the present invention may be of any quantity and of any suitable storage capacity. The arrays and area may alternatively be implemented by any type of data structure (e.g., queue, stack, linked list, record, etc.) or memory device (e.g., RAM, hard disk, etc.), and may be stored within any suitable system memory or storage device at any desired locations. The sequence counter may be implemented by any quantity of any type of hardware or software counter and may maintain any desired values. The seed value may be any value within any desired range. The filler or pad bit may be of any desired value, and may include any quantity of bits to accommodate the particular units of data being stored (e.g., bit, byte, word, etc.).

The present invention may utilize any type of conventional or other pseudo-random or random number generator to generate the sequence. The present invention may utilize any conventional or other error correction techniques to recover lost data or correct erroneous data. The present invention may store data on the media in any fashion and may be utilized in combination with any error correction schemes and/or data distribution schemes (e.g., offset, interleaving, etc.). The present invention may utilize any types of prompts (e.g., line prompts, windows, menus, etc.) to query the user and receive any type of information. The present invention may display files or other data in any manner or arrangement (e.g., list, window, etc.) to facilitate selection by a user via any suitable input device (e.g., mouse, voice, keyboard, etc.).

The present invention may partition the media and data in any fashion to accommodate the media storage capacity. The memory blocks and data sections may be of any quantity and include any desired storage capacity. The memory blocks may be stored on the media in any desired fashion (e.g., sequential, interleaved, etc.). The present invention may utilize any virtual or other system memory to accommodate the media storage capacity. The present invention may store any quantity of additional instances of data on the storage media in any desired manner or arrangement and utilize any type of consensus or other scheme to detect and correct errors. The consensus scheme may utilize any predetermined quantity of data instances (e.g., a majority, a super majority, mathematical formula, etc.) or any error threshold for instances having errors (e.g., the instance data value is utilized if the instance has a quantity of errors below the threshold) to determine the appropriate value for data. The header may include any desired information to indicate characteristics of the stored data.

The present invention is not limited to the specific applications disclosed herein, but may be utilized in substantially the same manner described above to encrypt or secure data. For example, the present invention may be utilized to encrypt data for any communication applications. The data may be arranged as described above and transmitted across any type of network (e.g., LAN, WAN, wireless, packet, etc.) where the receiver utilizes the seed value to decrypt the transmission.

From the foregoing description it will be appreciated that the invention makes available a novel method and apparatus for secure and fault tolerant data storage wherein data is distributed in a pseudo-random fashion across storage media to store the data in a secure manner and enable recovery of data in the event of media defects.

Having described preferred embodiments of a new and improved method and apparatus for secure and fault tolerant data storage, it is believed that other modifications, variations and changes will be suggested to those skilled in the art in view of the teachings set forth herein. It is therefore to be understood that all such variations, modifications and changes are believed to fall within the scope of the present invention as defined by the appended claims.

What is claimed is:

1. A system for distributing data across storage media in a manner to facilitate fault tolerant data storage, said system comprising:
a storage unit to store data on storage media received within said storage unit, wherein said storage media has a memory space encompassing a storage capacity of said storage media; and
a processor to manipulate and facilitate storage of said data across said storage media in a manner to provide fault tolerant storage of said data with respect to defects arising within said storage media, said processor including:
a data retrieval module to selectively retrieve data for storage on said storage media, wherein said data includes a plurality of data portions;
a data distribution module to distribute said data portions within said memory space in a pseudo-random fashion; and
a storage module to facilitate storage of said distributed data on said storage media via said storage unit to produce a pseudo-random distribution of said data across said storage media.

2. The system of claim 1 wherein said data distribution module includes:
a sequence generation module to generate a sequence of random numbers, wherein said random numbers are selectively associated with corresponding data portions, and wherein each associated random number has a value within a range of said memory space and identifies a location within that space to store said corresponding data portion; and
a data arrangement module to store each said data portion within said memory space location identified by said associated random number.

3. The system of claim 2 wherein said sequence generation module produces said sequence in accordance with a seed value.

4. The system of claim 3 wherein said data distribution module further includes:
a user module to prompt a user to enter said seed value and to retrieve said seed value entered by said user;
wherein said sequence generation module includes:
a seed module to produce said sequence in accordance with said entered seed value in response to said user entering that value; and
a default seed module to retrieve a default seed value and to produce said sequence in accordance with said default seed value in response to said user failing to enter said seed value.

5. The system of claim 1 wherein said data distribution module further includes:
a data load module to store said data portions sequentially in a first storage space; and
a data transfer module to retrieve data portions sequentially from said first storage space and to store those data portions in said pseudo-random fashion within a second storage space having a storage capacity of said storage media;
wherein said storage module includes:
a write module to facilitate sequential storage of said distributed data portions from said second storage space to said storage media, thereby distributing said data across said storage media in said pseudo-random fashion.

6. The system of claim 3 wherein said processor farther includes:
a data recovery module to retrieve data portions from said storage media and arrange said data portions in a manner to produce said data in original form.

7. The system of claim 6 wherein said data recovery module includes:
a sequence reproduction module to reproduce said sequence of random numbers utilized for said pseudo-random data distribution, wherein said random numbers are selectively associated with locations within said memory space, and wherein each associated random number identifies a location within said memory space to retrieve a corresponding data portion; and
a data organization module to retrieve each data portion from said memory space location identified by said associated random number, wherein said data portions are retrieved in order of said sequence to arrange said data in original form.

8. The system of claim 7 wherein said data recovery module further includes:
a user module to prompt a user to enter said seed value utilized for said pseudo-random distribution and to retrieve said seed value entered by said user;
wherein said sequence reproduction module includes:
a seed module to reproduce said sequence in accordance with said entered seed value in response to said user entering that value; and
a default seed module to retrieve a default seed value and to reproduce said sequence in accordance with said default seed value in response to said user failing to enter said seed value.

9. The system of claim 6 wherein said data recovery module further includes:
a data load module to retrieve data portions sequentially from said storage media and to store those data portions sequentially in a first storage space; and
a restoration module to retrieve data portions in the order of and from locations within said first storage space identified by said random number sequence to produce said data in original form and to sequentially store said ordered data portions in a temporary storage area.

10. The system of claim 9 wherein said data recovery module further includes:
a data selection module to facilitate selection of said restored data by said user; and
a data transfer module to retrieve said selected data from said temporary storage area and to store said selected data at a user specified location.

11. The system of claim 1 wherein said data distribution module includes:
a partition module to selectively partition said memory space into data blocks and to selectively partition said data into data sections, wherein each data section is associated with a corresponding data block; and
a block distribution module to distribute data portions of each data section in said pseudo-random fashion within an associated data block;
wherein said storage module includes:
a block storage module to facilitate sequential storage of each said data block onto said storage media.

12. The system of claim 5 wherein said processor includes virtual memory and at least one of said first and second storage spaces is at least partially defined within said virtual memory.

13. The system of claim 1 wherein said processor further includes:
a copy module to facilitate storage of additional instances of said data onto said storage media in response to said storage media having available storage space;
a verification module to determine the value of a particular data portion within each said data instance;
a value module to determine the appropriate value for said data portion in accordance with said values retrieved from said data instances; and
an update module to correct said data portion with said determined value.

14. The system of claim 13 wherein said value module includes:
a consensus module to determine said appropriate value based on a data portion value appearing within a predetermined quantity of data instances.

15. The system of claim 13 wherein said value module includes:
a consensus module to determine said appropriate value in accordance with a data instance having a quantity of errors below an error threshold.

16. The system of claim 6 wherein said data recovery module includes:
a security module to enable said retrieval of said data in original form in response to a user entering an appropriate password.

17. A program product apparatus having a computer readable medium with computer program logic recorded thereon for distributing data across storage media in a manner to facilitate fault tolerant data storage, wherein said storage media has a memory space encompassing a storage capacity of said storage media, said program product apparatus comprising:
a data retrieval module to selectively retrieve data for storage on said storage media, wherein said data includes a plurality of data portions;
a data distribution module to distribute said data portions within said memory space in a pseudo-random fashion; and
a storage module to facilitate storage of said distributed data on said storage media to produce a pseudo-random distribution of said data across said storage media.

18. The apparatus of claim 17 wherein said data distribution module includes:
a sequence generation module to generate a sequence of random numbers, wherein said random numbers are selectively associated with corresponding data portions, and wherein each associated random number has a value within a range of said memory space and identifies a location within that space to store said corresponding data portion; and
a data arrangement module to store each said data portion within said memory space location identified by said associated random number.

19. The apparatus of claim 18 further including:
a data recovery module to retrieve data portions from said storage media and arrange said data portions in a manner to produce said data in original form.

20. The apparatus of claim 19 wherein said data recovery module includes:
a sequence reproduction module to reproduce said sequence of random numbers utilized for said pseudo-random data distribution, wherein said random numbers are selectively associated with locations within said memory space, and wherein each associated random number identifies a location within said memory space to retrieve a corresponding data portion; and
a data organization module to retrieve each data portion from said memory space location identified by said associated random number, wherein said data portions are retrieved in order of said sequence to arrange said data in original form.

21. The apparatus of claim 17 wherein said data distribution module includes:
a partition module to selectively partition said memory space into data blocks and to selectively partition said data into data sections, wherein each data section is associated with a corresponding data block; and
a block distribution module to distribute data portions of each data section in said pseudo-random fashion within an associated data block;
wherein said storage module includes:
a block storage module to facilitate sequential storage of each said data block onto said storage media.

22. The apparatus of claim 17 further including:
a copy module to facilitate storage of additional instances of said data onto said storage media in response to said storage media having available storage space;
a verification module to determine the value of a particular data portion within each said data instance;
a value module to determine the appropriate value for said data portion in accordance with said values retrieved from said data instances; and
an update module to correct said data portion with said determined value.

23. The apparatus of claim 22 wherein said value module includes:
a consensus module to determine said appropriate value based on a data portion value appearing within a predetermined quantity of data instances.

24. The apparatus of claim 22 wherein said value module includes:
a consensus module to determine said appropriate value in accordance with a data instance having a quantity of errors below an error threshold.

25. The apparatus of claim 19 wherein said data recovery module includes:
a security module to enable said retrieval of said data in original form in response to a user entering an appropriate password.

26. A carrier signal having computer program logic embedded therein for distributing data across storage media in a manner to facilitate fault tolerant data storage, wherein said storage media has a memory space encompassing a storage capacity of said storage media, said carrier signal comprising:
a data retrieval module to selectively retrieve data for storage on said storage media, wherein said data includes a plurality of data portions;
a data distribution module to distribute said data portions within said memory space in a pseudo-random fashion; and
a storage module to facilitate storage of said distributed data on said storage media to produce a pseudo-random distribution of said data across said storage media.

27. The carrier signal of claim 26 wherein said data distribution module includes:
a sequence generation module to generate a sequence of random numbers, wherein said random numbers are selectively associated with corresponding data portions, and wherein each associated random number has a value within a range of said memory space and identifies a location within that space to store said corresponding data portion; and
a data arrangement module to store each said data portion within said memory space location identified by said associated random number.

28. The carrier signal of claim 27 further including:
a data recovery module to retrieve data portions from said storage media and arrange said data portions in a manner to produce said data in original form.

29. The carrier signal of claim 28 wherein said data recovery module includes:
a sequence reproduction module to reproduce said sequence of random numbers utilized for said pseudo-random data distribution, wherein said random numbers are selectively associated with locations within said memory space, and wherein each associated random number identifies a location within said memory space to retrieve a corresponding data portion; and
a data organization module to retrieve each data portion from said memory space location identified by said associated random number, wherein said data portions are retrieved in order of said sequence to arrange said data in original form.

30. The carrier signal of claim 26 wherein said data distribution module includes:
a partition module to selectively partition said memory space into data blocks and to selectively partition said data into data sections, wherein each data section is associated with a corresponding data block; and
a block distribution module to distribute data portions of each data section in said pseudo-random fashion within an associated data block;
wherein said storage module includes:
a block storage module to facilitate sequential storage of each said data block onto said storage media.

31. The carrier signal of claim 26 further including:
a copy module to facilitate storage of additional instances of said data onto said storage media in response to said storage media having available storage space;
a verification module to determine the value of a particular data portion within each said data instance;
a value module to determine the appropriate value for said data portion in accordance with said values retrieved from said data instances; and
an update module to correct said data portion with said determined value.

32. The carrier signal of claim 31 wherein said value module includes:
a consensus module to determine said appropriate value based on a data portion value appearing within a predetermined quantity of data instances.

33. The carrier signal of claim 31 wherein said value module includes:
a consensus module to determine said appropriate value in accordance with a data instance having a quantity of errors below an error threshold.

34. The carrier signal of claim 28 wherein said data recovery module includes:
a security module to enable said retrieval of said data in original form in response to a user entering an appropriate password.

35. A system for distributing data across storage media in a manner to facilitate fault tolerant data storage, wherein said storage media has a memory space encompassing a storage capacity of said storage media, said system comprising:
data retrieval means for selectively retrieving data for storage on said storage media, wherein said data includes a plurality of data portions;
data distribution means for distributing said data portions within said memory space in a pseudo-random fashion; and
storage means for storing said distributed data on said storage media to produce a pseudo-random distribution of said data across said storage media.

36. The system of claim 35 wherein said data distribution means includes:
sequence generation means for generating a sequence of random numbers, wherein said random numbers are selectively associated with corresponding data portions, and wherein each associated random number has a value within a range of said memory space and identifies a location within that space to store said corresponding data portion; and
data arrangement means for storing each said data portion within said memory space location identified by said associated random number.

37. The system of claim 36 further including:
data recovery means for retrieving data portions from said storage media and arranging said data portions in a manner to produce said data in original form.

38. The system of claim 37 wherein said data recovery means includes:
sequence reproduction means for reproducing said sequence of random numbers utilized for said pseudo-random data distribution, wherein said random numbers are selectively associated with locations within said memory space, and wherein each associated random number identifies a location within said memory space to retrieve a corresponding data portion; and
data organization means for retrieving each data portion from said memory space location identified by said associated random number, wherein said data portions are retrieved in order of said sequence to arrange said data in original form.

39. The system of claim 35 wherein said data distribution means includes:
partition means for selectively partitioning said memory space into data blocks and for selectively partitioning said data into data sections, wherein each data section is associated with a corresponding data block; and
block distribution means for distributing data portions of each data section in said pseudo-random fashion within an associated data block;
wherein said storage means includes:
block storage means for storing each said data block sequentially onto said storage media.

40. The system of claim 35 further including:
copy means for storing additional instances of said data onto said storage media in response to said storage media having available storage space;
verification means for determining the value of a particular data portion within each said data instance;
value means for determining the appropriate value for said data portion in accordance with said values retrieved from said data instances; and
update means for correcting said data portion with said determined value.

41. The system of claim 40 wherein said value means includes:
consensus means for determining said appropriate value based on a data portion value appearing within a predetermined quantity of data instances.

42. The system of claim 40 wherein said value means includes:
consensus means for determining said appropriate value in accordance with a data instance having a quantity of errors below an error threshold.

43. The system of claim 37 wherein said data recovery means includes:
security means for enabling said retrieval of said data in original form in response to a user entering an appropriate password.

44. A method of distributing data across storage media in a manner to facilitate fault tolerant data storage, wherein said storage media has a memory space encompassing a storage capacity of said storage media, said method comprising the steps of:
(a) selectively retrieving data for storage on said storage media, wherein said data includes a plurality of data portions;
(b) distributing said data portions within said memory space in a pseudo-random fashion; and
(c) storing said distributed data on said storage media to produce a pseudo-random distribution of said data across said storage media.

45. The method of claim 44 wherein step (b) further includes:
(b.1) generating a sequence of random numbers, wherein said random numbers are selectively associated with corresponding data portions, and wherein each associated random number has a value within a range of said memory space and identifies a location within that space to store said corresponding data portion; and
(b.2) storing each said data portion within said memory space location identified by said associated random number.

46. The method of claim 45 wherein step (b.1) further includes:
(b.1.1) generating said sequence of random numbers in accordance with a seed value.

47. The method of claim 46 wherein step (b.1) further includes:
(b.1.1) prompting a user to enter said seed value and retrieving said seed value entered by said user;
(b.1.2) generating said sequence in accordance with said entered seed value in response to said user entering that value; and
(b.1.3) retrieving a default seed value and generating said sequence in accordance with said default seed value in response to said user failing to enter said seed value.

48. The method of claim 44 wherein step (b) further includes:
(b.1) storing said data portions sequentially in a first storage space; and
(b.2) retrieving data portions sequentially from said first storage space and storing those data portions in said pseudo-random fashion within a second storage space having a storage capacity of said storage media;
wherein step (c) further includes:
(c.1) storing said distributed data portions from said second storage space sequentially onto said storage media, thereby distributing said data across said storage media in said pseudo-random fashion.

49. The method of claim 46 further including:
(d) retrieving data portions from said storage media and arranging said data portions in a manner to produce said data in original form.

50. The method of claim 49 wherein step (d) further includes:
(d.1) reproducing said sequence of random numbers utilized for said pseudo-random data distribution, wherein said random numbers are selectively associated with locations within said memory space, and wherein each associated random number identifies a location within said memory space to retrieve a corresponding data portion; and
(d.2) retrieving each data portion from said memory space location identified by said associated random number, wherein said data portions are retrieved in order of said sequence to arrange said data in original form.

51. The method of claim 50 wherein step (d.1) further includes:
(d.1.1) prompting a user to enter said seed value utilized for said pseudo-random distribution and retrieving said seed value entered by said user;
(d.1.2) reproducing said sequence in accordance with said entered seed value in response to said user entering that value; and
(d.1.3) retrieving a default seed value and reproducing said sequence in accordance with said default seed value in response to said user failing to enter said seed value.

52. The method of claim 49 wherein step (d) further includes:
(d.1) retrieving data portions sequentially from said storage media and storing those data portions sequentially in a first storage space; and
(d.2) retrieving data portions in the order of and from locations within said first storage space identified by said random number sequence to produce said data in original form and sequentially storing said ordered data portions in a temporary storage area.

53. The method of claim 52 wherein step (d) further includes:
(d.3) facilitating selection of said restored data by said user; and
(d.4) retrieving said selected data from said temporary storage area and storing said selected data at a user specified location.

54. The method of claim 44 wherein step (b) further includes:
(b.1) selectively partitioning said memory space into data b locks and selectively partitioning said data into data sections, wherein each data section is associated with a corresponding data block; and
(b.2) distributing data portions of each data section in said pseudo-random fashion within an associated data block;
wherein step (c) further includes:
(c.1) storing each said data block sequentially onto said storage media.

55. The method of claim 48 wherein at least one of said first and second storage spaces is at least partially defined within virtual memory.

56. The method of claim 44 further including:
(d) storing additional instances of said data onto said storage media in response to said storage media having available storage space;
(e) determining the value of a particular data portion within each said data instance;
(f) determining the appropriate value for said data portion in accordance with said values retrieved from said data instances; and
(g) correcting said data portion with said determined value.

57. The method of claim 56 wherein step (f) further includes:
(f.1) determining said appropriate value based on a data portion value appearing within a predetermined quantity of data instances.

58. The method of claim 56 wherein step (f) further includes:
(f.1) determining said appropriate value in accordance with a data instance having a quantity of errors below an error threshold.

59. The method of claim 49 wherein step (d) further includes:
(d.1) enabling said retrieval of said data in original form in response to a user entering an appropriate password.
